(19) United States
(12) Patent Application Publication
(10) Pub. No.: US 2012/0144419 A1
(43) Pub. Date: Jun. 7, 2012

(54) INTERACTIVE TELEVISION

(75) Inventors: Li Ming Gu, Beijing (CN); Carrie Yee Kave Wong, Beijing (CN); Wei Wu, Beijing (CN)

(73) Assignee: Microsoft Corporation, Redmond, WA (US)

(21) Appl. No.: 12/961,011

(22) Filed: Dec. 6, 2010

(51) Int. Cl. H04N 7/025

(52) U.S. Cl. 725/34

(57) ABSTRACT

One or more techniques and/or systems are disclosed for interactive television. A desired contextual probability factor is identified for respective potential interactive content, such as stored in a database, based on information relating to a consumer context. Interactive contextual content is selectively activated to run concurrently with television programming running on a consumer display, where the activated contextual content is selected based on a desired consumer interest probability factor. When the consumer interacts with the contextual content a response is provided, comprising corresponding response information, which can be sent to a consumer device associated with interactive content.

### BACKGROUND

Television programming can comprise a variety of formats provided to viewing consumers over a variety of devices. For example, regularly broadcast television shows are typically broadcast to viewers that use televisions to view the programming. The programming can be received over the air (e.g., free digital programming using television signals), using a wired connection (e.g., using a cable service), using a satellite receiver (e.g., a satellite service), over a network connection (e.g., using an Internet connection), or a wireless connection (e.g., mobile-based connection). Additionally, consumers can choose to view programming at different times using different devices, such as Internet television, mobile television, recorded programming (e.g., digital video recordings), and a plurality of others.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Television programming typically relies of advertising (e.g., and some subscriptions) to generate revenue. Usually, advertisements are inserted in between parts or segments of television programming. However, these ads are not highly targeted, nor are they particularly interactive. For example, if the consumer views an ad for a local pizza restaurant during a break in a sports game, there is little they can do to interact with the advertisement. Instead, they may need to make a call to the restaurant (if they remember the number from the ad) to order a delivery, or go to the restaurant to pick up the pizza.

Current or previous techniques and systems for interactive television do provide some interaction for the consumer. For example, some techniques provide for displaying small advertisements, offers, or instructions for more content during the television programming. The consumer can select the interactive content using their remote, and are typically taken to another screen that merely provides more information about the product or service, without any further interactive content. Further, typical interactive content interrupts the consumer programming, which may result in negative reactions from the consumer.

Accordingly, one or more techniques and/or systems are disclosed that provide for enhanced interactive television that is more engaging than current or previous techniques. Interactive content is identified that is more targeted to the consumer, using contextual information about the consumer. Further, the selected content can be displayed to the consumer with the programming at more appropriate times. Additionally, when the consumer interacts with the content, enhanced responses are provided, for example, where desired content can be delivered to selected consumer devices, and/or third-party devices selected by the consumer.

In one embodiment for interactive television, a desired contextual probability factor can be identified for potential interactive content, based on consumer contextual information. Contextual content, such as interactive content, is activate to run concurrently with television programming, such as viewed by the consumer, where the activated contextual content is selected based on a desired consumer interest probability factor (e.g., a consumer interest threshold value). A consumer interaction with the contextual content can be responded to by providing corresponding response information, which can be sent to an associated consumer device (e.g., TV, mobile device, etc.)

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram of an exemplary method for interactive television.

FIG. 2 is a flow diagram illustrating an example embodiment of an implementation of one or more techniques described herein.

FIG. 3 illustrates an example embodiment of a system that can implement one or more techniques and/or systems described herein.

FIG. 4 is a flow diagram illustrating one embodiment implementing one or more techniques and/or systems described herein.

FIG. 5 is a component diagram of an exemplary system for interactive television.

FIG. 6 is a component diagram illustrating one embodiment of an implementation of one or more systems described herein.

FIG. 7 is an illustration of an exemplary computer-readable medium comprising processor-executable instructions configured to embody one or more of the provisions set forth herein.

FIG. 8 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

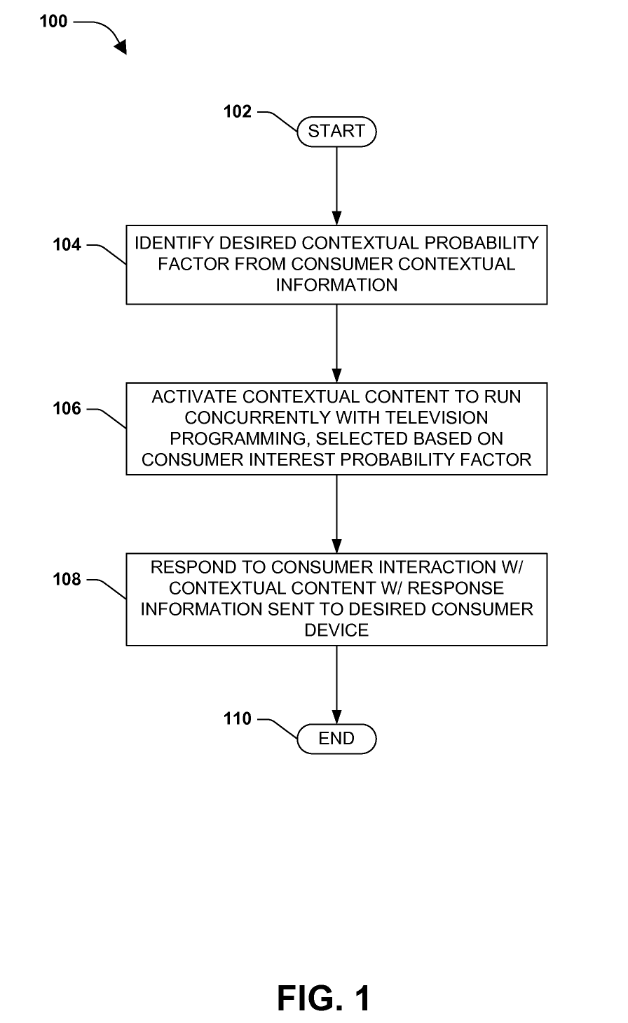

A method may be devised that provides for interactive television, for example, where interactive content is more engaging to the consumer of the interactive television, and provides more opportunities for interaction. FIG. 1 is a flow diagram of an exemplary method 100 for interactive television. The exemplary method 100 begins at 102 and involves identifying a desired contextual probability factor based on consumer contextual information, at 104. In one embodiment, the desired contextual probability factor can comprise a probability value used to compare against a threshold, where the probability describes a likelihood that the consumer may desire to view interactive content.

For example, contextual information may comprise current, relevant information for the consumer (e.g., person watching the television), such as programming, time of day, location, current viewing context (e.g., mobile, living room, hotel, etc.), and the consumer linked information. In one embodiment, the contextual information can be identified from one or more locations, such as provided by a broadcaster of the programming content, from a consumer's account, a set top box or programming reception component in the television, and/or any component, service, system, etc. that may be available and authorized to provide the contextual information, for example.

In one embodiment, the desired contextual information can comprise information that provides sufficient context for a provision of interactive elements for the interactive television. For example, where a local entity wishes to provide interactive coupons to a particular geographical location (e.g., to service a local store in particular), merely the location of the consumer may be a desired amount of contextual information to deploy the coupons. In another embodiment, the desired contextual information can comprise an available amount of contextual information, for example, where more information can provide a more accurate context, which may allow for a better match (e.g., meet a higher probability factor) for contextual content provided for the interactive television.

At 106 in the exemplary method 100, contextual content is activated to run concurrently with television programming, where the activated contextual content is selected based on a desired consumer interest probability factor (e.g., a value of probability that the consumer may be interested in viewing contextual content). In one embodiment, contextual content can comprise content that is not part of the television programming (e.g., TV show), such as provided by the broadcast control service (e.g., broadcaster). For example, the broadcaster (e.g., cable service, satellite service, Internet-based service, over-the-air service, or other programming service provider) may be providing a television show to the consumer, such as by using a “set-top box” (e.g., external or internal converter, receiver, digitizer, antenna, computer, and/or other broadcast service receiving component) connected to the service (e.g., wired or wirelessly). In this embodiment, the contextual content can be content provided separately from the broadcaster programming, for example.

The contextual content may comprise advertising-based content, such as intended to sell a service and/or product. For example, the activated contextual content may be promotional material (e.g., text, images, video or a combination) for a coupon for a product (e.g., pizza) that appears with the programming content (e.g., in-line with, on-top of, in a separate window, etc.). In one embodiment, the contextual content may comprise some value-added content for the consumer. For example, while watching a music video contextual content may comprise an indication that the song being viewed can be downloaded as a ringtone to the consumer's mobile phone. As another example, the contextual content can comprise an indication to identify additional scheduling information about the programming, detailed product information, or even details about something being viewed in the programming (e.g., a recipe for a dish being prepared on a cooking show).

Activating the contextual content can comprise merely sending an activation command, such as to the set-top-box, to run the selected content. In one embodiment, the contextual content can be selected based on a consumer interest matching factor between the contextual information identified and the contextual content. In one embodiment, a probability determiner, such as a classification algorithm, may be used to identify the probability factor. For example, the contextual information may be input to the probability determiner, which can be run over a plurality of available contextual contents (e.g., interactive ads), such as stored locally (e.g., to the viewing device) or remotely in a database. In this example, a consumer interest probability factor (e.g., probability that the consumer may be interested in viewing content of an ad) can be determined for the respective available contextual contents, and the content having a desired (e.g., highest, or most compatible) probability factor can be selected for activation.

At 108 in the exemplary method 100, a consumer interaction with the contextual content is responded to by providing corresponding response information to be sent to an associated consumer device. For example, interactive television comprises and ability of a user (consumer) to interact with content viewed on the television (e.g., by selecting a button on a remote, touching a virtual button on a screen, and/or some other interaction that results in a response action) in order to provide a desired response.

In one embodiment, the provided response information can comprise additional contextual content that is sent to the consumer's television (or other viewing device), and run concurrently or in lieu of the programming content. In this embodiment, the consumer can have one or more devices (e.g., television, mobile phone, mobile media player, computer, etc.) associated with the interactive television experience. For example, the consumer may press a button on their remote control that indicates an interaction with the activated contextual content (e.g., “press select on your remote to interact”), and additional contextual content (e.g., a coupon, more details about the product, a cost for the service, etc.) can be provided on the television that the consumer has associated with interactive content. Alternatively, the consumer may wish to have the response content sent to another device, or a third-party device to access separately from the television, and can associate a plurality of desired devices with the interactive television content, for example.

Having responded to the consumer interaction with the contextual content, the exemplary method 100 ends at 110.

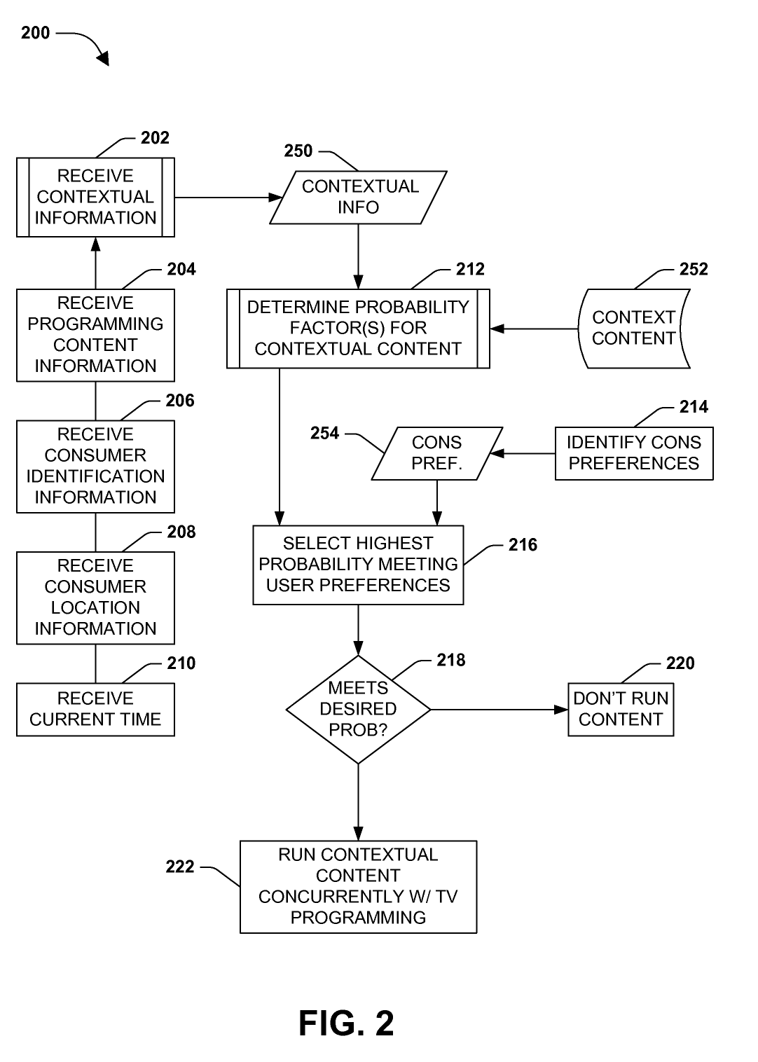

FIG. 2 is a flow diagram illustrating an example embodiment 200 of an implementation of one or more techniques described herein. At 202, contextual information is received for the consumer. In this embodiment, contextual information for the consumer watching television programming, for example, can be continually or intermittently received. Programming content information can be received and identified, at 204, which may comprise a name of the program, type of program (e.g., sports/football, TV series/comedy, movie/action-adventure, etc.), and what is being shown in the content at a particular moment (e.g., commercial for pizza, live action sports, scene of show in the Caribbean), for example.

At 206, a consumer identity can be received and identified, for example, which may comprise a string, code, or some other specific key that identifies the consumer. In one embodiment, a particular ID may be associated with the consumer when they subscribe to a broadcasting service, such as a subscription programming service (e.g., cable, satellite, Internet-based, etc.), for example, often used for billing, user preferences, and/or security purposes, and this may be used to identify the consumer.

In one embodiment, the consumer ID may be associated with account information comprising consumer information that may be useful in identifying additional contextual information for the user. For example, the consumer ID may be used to identify the consumer's programming preferences, such as particular channel subscriptions (e.g., sports, movies, and foreign language), previous viewing history (e.g., pay-per-view events, program viewing and/or recording history), viewing schedule, even information contained in a personalized channel guide. As another example, the consumer ID may be used to identify demographic information about the consumer, such as age, gender, income, and/or other information made available to the subscription service.

At 208, consumer location information can be received and identified. For example, the location of the consumer watching the programming may be determined from user input, location tracking (e.g., GPS), account information, or may be detected using a signal associated with the broadcasting and/or receiver (e.g., IP address, ping detection, signal loss, sub-channel signal detection). At 210, a current time can be received and identified, for example, using a broadcasting signal (e.g., sub-channel time signal), or other time collection techniques. In this embodiment 200, the consumer related information received can be used as contextual information 250 for the consumer.

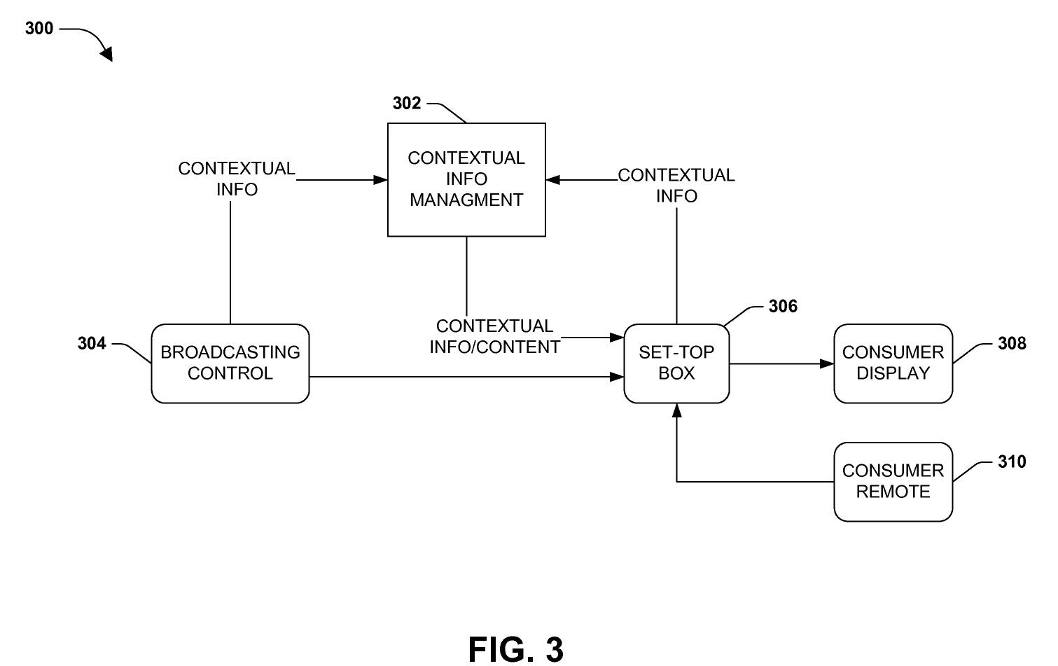

FIG. 3 illustrates an example embodiment 300 of a system that can implement one or more techniques and/or systems described herein. For example, contextual information can be received from a broadcasting control service 304 (e.g., providing the programming) at a contextual information manager 302, and from a set-top box 306 (e.g., associated with, or in the television). In one embodiment, the contextual information received from the broadcasting control service 304 may comprise the television programming information for the consumer. In one embodiment, the contextual information received from the set top box 306, which may receive the television programming and deliver it to a consumer's television, may comprise the time, location, user ID, and other information, for example (e.g., 204, 206, 208, 210 of FIG. 2). Further, sensors (not shown) may be used to collect contextual information, such as location, time, activities (e.g., GPS, accelerometer, touch sensor, temperature, etc.), for example, which may be comprised in the set-top box, mobile device, and/or some program receiver.

Returning to FIG. 2, at 212, the identified contextual information 250 can be used to determine a probability factor for contextual content 252, or rather a consumer interest probability factor for contextual content (e.g., how likely it is that a consumer will be interested in the particular contextual or supplemental content based upon the overall “context” of the user/consumer). In one embodiment, identifying the contextual probability factor can comprise identifying a probability for a contextual content (e.g., advertisement, offer, enhancement content) based on current programming viewed by the consumer for a current location of the consumer. That is, for example, the current time, programming and consumer location context can be used to determine a probability factor for respective contextual contents, such as stored in a database.

In one embodiment, the location, programming and time can be input to a trained probability determination algorithm, which can be run over the respective contextual contents 252 (e.g., media that can be run concurrently with the programming). As an example, running a probability determiner over each of the contextual contents can produce a probability factor for the respective contextual contents, where the probability factor represents a likelihood that the consumer will react positively to the contextual content.

In one embodiment, a database of contextual content can be stored locally for the consumer, such as on the set-top box (e.g., 306 of FIG. 3), for example, which can allow for more efficient deployment. In this embodiment, updated content can be loaded to (e.g., downloaded) the set-top box periodically. In another embodiment, a data base may reside remotely, for example, on a remote server networked with a contextual information manager (e.g., 302 of FIG. 3). For example, one or more contextual content providers (e.g., ad agencies/services) may have servers networked (e.g., through an Internet connection) with the contextual information manager 302. In this way, for example, contextual content that is available in the database can be run through the probability determiner.

At 214 in the example embodiment 200 of FIG. 2, user preferences can be identified. In one embodiment, identifying consumer preferences, comprising indentifying a contextual content type preference. For example, a consumer may wish to merely see special offers (e.g., sales, discounts, coupons, special financing deals, etc.) from companies, and/or merely see content that can be downloaded and used (e.g., media downloaded for later use, such as songs, movies, etc.), and/or detailed information content about products/services. In this example, the consumer may be provided with an opportunity to select a type of contextual content, such as through their TV, online, and/or when signing up for a broadcasting service. In this way, contextual/supplemental content may be delivered in a manner desirable to the consumer.

In another embodiment, the consumer preference may comprise a contextual content display preference, a consumer timing preference, and/or a contextual content delivery preference. For example, the consumer may desire to merely view particular types of interactive content displays on their TV while viewing, at certain times, and delivered in a particular way. As an illustrative example, the consumer may merely wish to see a small banner at the bottom of the TV picture, so that it does not obscure the TV programming. Further, in this example, the consumer may not wish to see interactive content while viewing particular programming, at particular times (e.g., football on Sundays).

Additionally, the consumer may have a desired content delivery preference, for example, when interacting with contextual content. As an example, when the consumer interacts with a coupon offer on the TV, they may prefer to have the response content delivered to their mobile device for later use. As another example, the consumer may have a preferred device for downloading media (e.g., songs), and another when retrieving detailed information about a product. The consumer may also choose to have content delivered to a third-party device, such as to provide consumer contact information (e.g., a callback number or email for a merchant or service), or to a remote server, for example, for later retrieval by the consumer).

In another embodiment, consumer preferences 254 may be identified by using historical consumer interaction with contextual content. For example, if a user typically ignores (or interacts with) a particular type of contextual content, or content delivered in a particular way, or at a particular time, etc., these preferences can be saved. In this embodiment, the saved preferences can be reviewed to help identify the consumer preferences, for example, and may be combined with selected user preferences.

At 216 in the exemplary embodiment 200, a highest probability factor can be selected that also meets desired user preferences 254. That is, in one embodiment, identifying the desired contextual probability factor (e.g., associated with a contextual content) can be based on consumer contextual information 250 and consumer preferences 254. As an example, the contextual content 252 that has a highest probability factor can be compared with the consumer preferences 214 to determine if the content is compatible with the preferences (e.g., preferred delivery, content-type, timing, etc.). If compatible, in this example, the contextual content can be selected. Otherwise, a next contextual content having a next-highest probability factor can be compared with the preferences, for example, until a matching contextual content is selected.

At 218, it can be determined whether the selected contextual content meets a desired probability factor (e.g., a selected threshold value). For example, while the selected contextual content may meet the desired preferences of the consumer, it may not meet a selected threshold value for a consumer interest probability factor. In this example, if the content does not meet the desired probability (e.g., is not likely enough to be of interest to the consumer), the selected content is not run, at 220 (e.g., shown to the consumer as interactive content).

While interactive television content may provide for an enhanced experience for consumers, for example, situations (e.g., identified by contextual information) may vary where consumers are more likely to react positively or negatively to the interactive content, particularly if it does or does not meet the consumer's potential needs at that time. For example, if a consumer is currently watching a cooking program, and the interactive content provided comprises information about the recipe (e.g., “select the content if you would like to have the recipe downloaded to your computer now”), they are more likely to react positively. However, if the consumer is watching an exciting sports program, and the interactive content comprises an advertisement for a political candidate (e.g., “select the content to learn more about this candidate”), the consumer may be more likely to react negatively (e.g., and possibly opt-out of the interactive television programming).

Therefore, in this embodiment, a desired threshold (e.g., regarding how likely it is that a consumer will be interested in particular contextual content) can be selected to allow contextual content to be used. In one embodiment, the threshold may be selected by the user, the broadcaster, the contextual content supplier, and/or a combination of these or others. In another embodiment, the threshold may be selected based consumer preferences, for example, and may change based on historical information for the consumer.

If the probability meets the desired threshold, at 222, the contextual content can be run (activated) concurrently with the TV programming. In one embodiment, activating the contextual content can comprise using a set top box to run the contextual content so that the content can be viewed by the consumer at a same time as the television programming from a broadcasting control system. For example, as illustrated in FIG. 3, the contextual information manager 302 can activate the selected contextual content on the set-top box 306, so that it is displayed on the consumer display 308 (e.g., television, computer monitor, mobile device) at the same time as programming from the broadcast control service 304.

In one embodiment, the contextual content may be provided by the contextual information manager 302, such as stored on a server and downloaded to the set-top box 306. In another embodiment, the contextual content may reside on the set-top box 306, and it can be activated using a connection to the contextual information manager 302. In another embodiment, the contextual information manager 302 may be associated with (e.g., comprised in or with) the broadcast control service, and an activation signal can be sent to the set-top box, or a combined program-contextual content signal may be sent to the set-top box. Further, in the example embodiment 300 of FIG. 3, the consumer may respond to the interactive content using a remote device 310 (e.g., a remote control for the television, or set-top box).

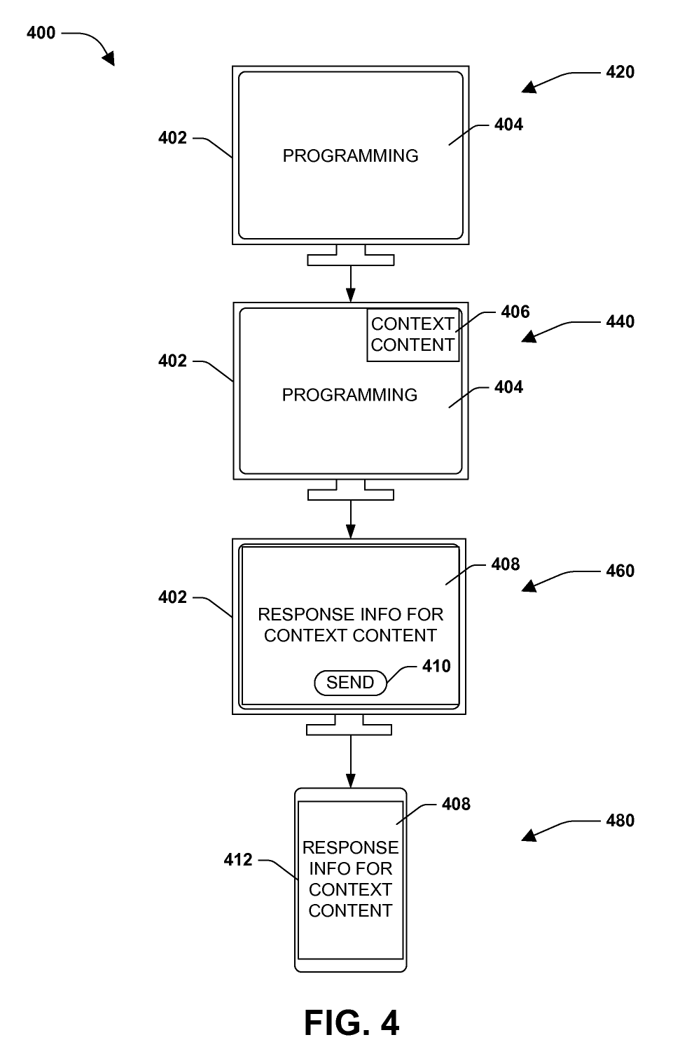

FIG. 4 is a flow diagram illustrating one embodiment 400 implementing one or more techniques and/or systems described herein. As described above, programming 404 (e.g., television programming provided by the broadcast control service and directed to the television by the set-top box) can be displayed on the consumer display 402 (e.g., television), at 420.

At 440, the contextual content 406 selected to run concurrently with the programming 404 (e.g., content that meets the desired threshold probability) can be activated and displayed on the consumer display 402. In one embodiment the user may see a message in the contextual content 406 that indicates how the user may interact with the content 406 (e.g., “press the interaction button on your remote”), along with information about the content (e.g., “press the interaction button on your remote to receive a coupon for a five dollar large pizza at PizzaKing”). In one embodiment, the user can respond to the contextual content using their remote control for the television or receiver (e.g., set-top box).

At 460 and 480, response information can be provided for the consumer in response to the interaction with the contextual content 406. In one embodiment, sending corresponding response information to the associated consumer device can comprise sending response information to the consumer's display, as in 460. For example, the response information 408 can comprise additional information for the contextual information, such as displaying the terms of the coupon for a pizza. Further, in this example, the response information 408 may comprise additional interactive content 410, where selecting the additional content 410 can provide for response information to be sent to another selected consumer device.

In one embodiment, the associated consumer device can comprise an associated consumer selected mobile device, for example, as shown at 480. In this example, the response information 408 can be sent to the consumer's mobile device (e.g., smartphone), such as for later user by the consumer (e.g., using the coupon at the PizzaKing store to purchase the large pizza). In another embodiment, the associated consumer device may comprise a third-party device used to provide the third-party with consumer contact information. For example, the consumer may wish to have a third-party contact them to continue the interaction (e.g., to purchase goods or services, participate in a survey, etc.). In this example, information about the consumer (e.g., contact information or consumer ID) can be sent to a third-party server, email, phone, etc.

In another embodiment, the associated consumer device may comprise a consumer selected online service device used to link the consumer with information about the contextual content. For example, the interactive content may provide a way for the user to link to additional information online about a particular service or good. Additionally, in one embodiment, the response information may comprise account information linked to the consumer that allows them to log-into a service to later retrieve information. For example, a coupon for a restaurant may run on the interactive television programming; the consumer can interact by “saving as a favorite”, and after the consumer's programming has ended they can go to the restaurant, retrieve the content from a remote server using their mobile device, and use the coupon at the restaurant.

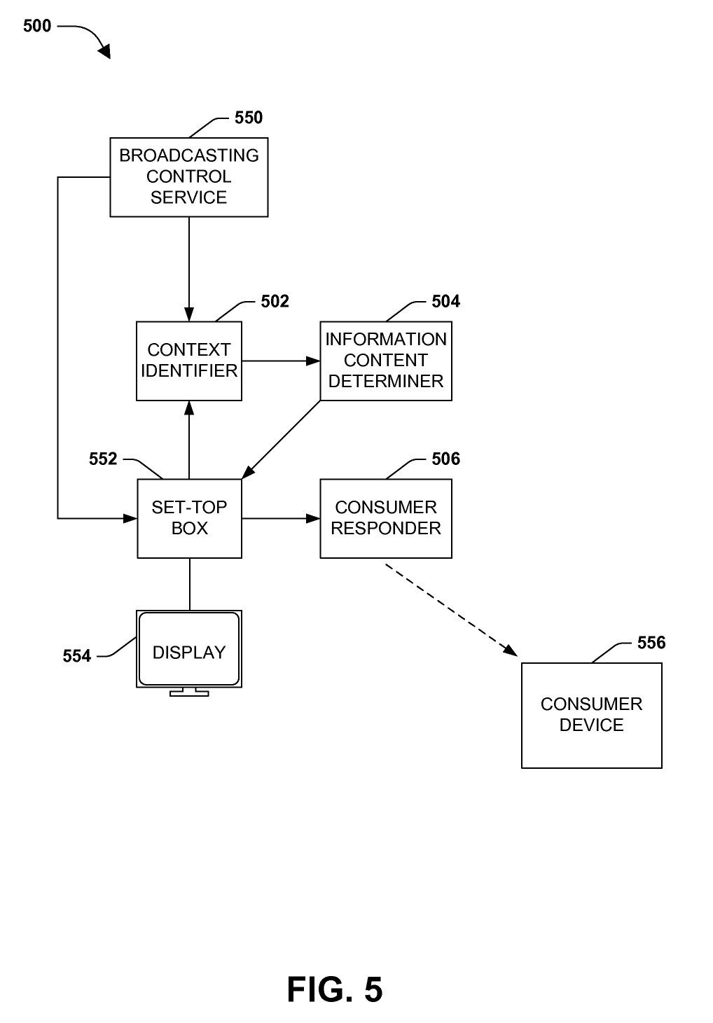

A system may be devised that provides for interactive television, for example, where interactive content is more engaging to the consumer of the interactive television, and provides more opportunities for interaction than contextual free advertisements, for example. FIG. 5 is a component diagram of an exemplary system 500 for interactive television. A context identification component 502 identifies contextual information for a consumer of the interactive television. The context identification component 502 can identify contextual information from a broadcast control service 550 that is communicatively coupled with the context identification component 502, where the broadcast control service 550 provides television content to the consumer (e.g., television programming). Further, the context identification component 502 can identify contextual information from a set-top box 552 that is operably coupled with a consumer television content display 554 (e.g., television), and which is also communicatively coupled with the context identification component 502.

An information content determination component 504 is operably coupled with the context identification component 502, and is used to identify information content that can be concurrently run with the television content on the consumer television content display 554. For example, the context identification component 502 can retrieve contextual information about what the consumer is watching, when, and where, and the information content determination component 504 can use the contextual information to identify appropriate contextual content (e.g., advertisement, offer, consumer enhancement information) that can run along with the television programming.

A consumer response component 506 is operably coupled with the set-top box 552, and is used to send response information to an associated consumer device 556 in response to a consumer interaction with the information content. For example, the use may interact with the information content (e.g., offer) running with the programming, such as by pressing a button on their remote control, and the consumer response component 506 can respond (e.g., after receiving an indication of interaction from the set-top box) by sending responsive information to the selected consumer device. In some embodiments, the consumer device 556 may comprise the consumer display 554 used for the interaction; and/or an alternate device, such as a mobile device, computer, remote server, or a third-party device (e.g., server)/

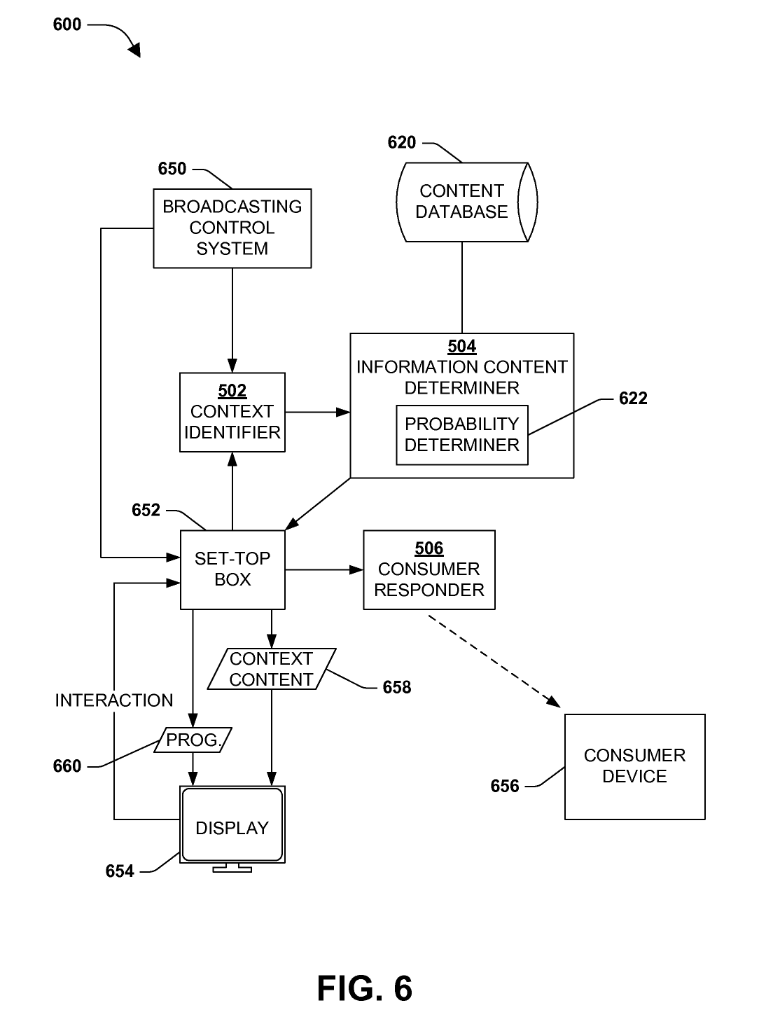

FIG. 6 is a component diagram illustrating one embodiment 600 of an implementation of one or more systems described herein. An information content database 620 can comprise a plurality of information content segments, and can be operably coupled with the information content determination component 504, such as to identify appropriate contextual content 658 to run concurrently with television programming 660. In one embodiment, the information content database 620 can comprise potential contextual content that can be used for the interactive television, where the content can be continually or intermittently updated, such as from content providers (e.g., advertisers) that are communicatively connected to the database.

In one embodiment, the information content database 620 may be disposed on a remote server, such as associated with the information content determination component 504. In another embodiment, the information content database 620 may be disposed on a set-top box 652 (e.g., internal or external receiver, controller, computer, etc.) associated with the consumer display device 654 (e.g., television, mobile device, computer monitor).

In one embodiment, the information content 658 that is identified by the information content determination component 504 can be configured to be displayed at a same time as the television content 660 (programming) to the consumer. That is, for example, the contextual content 658 can be run inline with or on-top of the programming content, or in some manner where both contents 658, 660 are run concurrently (e.g., side-by-side). In one embodiment, the contextual content 658 (information content) can comprise an advertisement, such as an ad for a product or service, an offer to immediately purchase a product, a deal, coupon, or sale; or the content can comprise some form of consumer added value service, such as additional information about content in the programming.

The information content determination component 504 can comprise a probability determination component 622. The probability determination component 622 can combine the contextual information (e.g., provided by the context identification component 502) with an information content from the content database 620 to determine a consumer interest probability. For example, the probability determination component 622 can use the contextual information to determine a probability for respective information content segments in the database 620. Further, the probability determination component 622 can select the information content segment that has a desired consumer interest probability (e.g., meets a set probability and consumer preferences).

The consumer response component 506 can send additional information (e.g. more details) about a subject of the information content 658 (e.g., interactive content selected by the consumer) to an associated consumer device 656, such as the display 654, a mobile device (e.g., phone). Further, the consumer response component 506 can send a sale related offer for a subject of the information content to an associated consumer device 656, and/or purchased content (e.g., media such as songs, ringtone, etc.) related to a subject of the information content to an associated consumer device (e.g., downloaded to a media player, a computer, or server). Additionally, the consumer response component 506 can send consumer contact information to a third-party, such as to a third-party server for later retrieval. Also, consumer preference information can be sent to the information content determination component 504, such as to update consumer preferences about preferred information content interaction, for example.

In one embodiment, the consumer responding component 506 can be associated with (e.g., disposed in) the set-top box 652. In another embodiment, the consumer responding component 506 may be associated with a contextual information manager (e.g., 302 of FIG. 3) that is remote from the set-top box 652. In one embodiment, certain components (or all) of the exemplary system 600 may be associated with the broadcasting control service, for example, and comprise a system that works in conjunction with a service providing programming 660 for the consumer. In one embodiment, parts or all of the exemplary system 600 may be disposed on the set-top box, and communicatively coupled (e.g., networked) with other elements of the exemplary system 600.

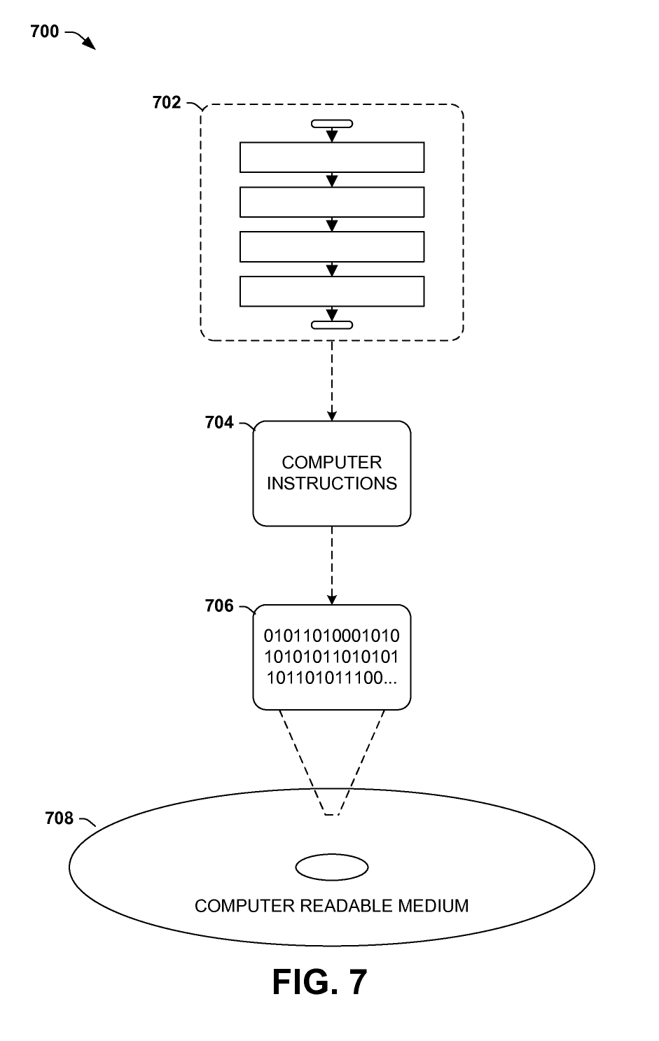

Still another embodiment involves a computer-readable medium comprising processor-executable instructions configured to implement one or more of the techniques presented herein. An exemplary computer-readable medium that may be devised in these ways is illustrated in FIG. 7, wherein the implementation 700 comprises a computer-readable medium 708 (e.g., a CD-R, DVD-R, or a platter of a hard disk drive), on which is encoded computer-readable data 706. This computer-readable data 706 in turn comprises a set of computer instructions 704 configured to operate according to one or more of the principles set forth herein. In one such embodiment 702, the processor-executable instructions 704 may be configured to perform a method, such as at least some of the exemplary method 100 of FIG. 1, for example. In another such embodiment, the processor-executable instructions 704 may be configured to implement a system, such as at least some of the exemplary system 500 of FIG. 5, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

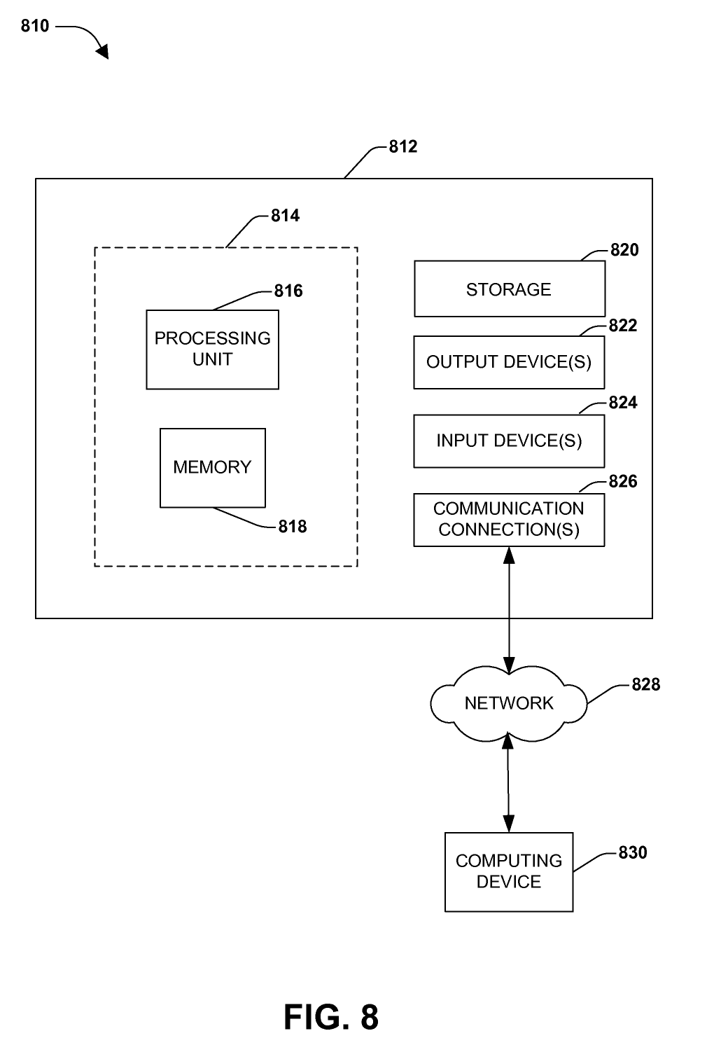

FIG. 8 and the following discussion provide a brief, general description of a suitable computing environment to implement embodiments of one or more of the provisions set forth herein. The operating environment of FIG. 8 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 8 illustrates an example of a system 810 comprising a computing device 812 configured to implement one or more embodiments provided herein. In one configuration, computing device 812 includes at least one processing unit 816 and memory 818. Depending on the exact configuration and type of computing device, memory 818 may be volatile (such as RAM, for example), non-volatile (such as ROM, flash memory, etc., for example) or some combination of the two. This configuration is illustrated in FIG. 8 by dashed line 814.

In other embodiments, device 812 may include additional features and/or functionality. For example, device 812 may also include additional storage (e.g., removable and/or non-removable) including, but not limited to, magnetic storage, optical storage, and the like. Such additional storage is illustrated in FIG. 8 by storage 820. In one embodiment, computer readable instructions to implement one or more embodiments provided herein may be in storage 820. Storage 820 may also store other computer readable instructions to implement an operating system, an application program, and the like. Computer readable instructions may be loaded in memory 818 for execution by processing unit 816, for example.

The term “computer readable media” as used herein includes computer storage media. Computer storage media includes volatile and nonvolatile, removable and non-removable media implemented in any method or technology for storage of information such as computer readable instructions or other data. Memory 818 and storage 820 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 812. Any such computer storage media may be part of device 812.

Device 812 may also include communication connection(s) 826 that allows device 812 to communicate with other devices. Communication connection(s) 826 may include, but is not limited to, a modem, a Network Interface Card (NIC), an integrated network interface, a radio frequency transmitter/receiver, an infrared port, a USB connection, or other interfaces for connecting computing device 812 to other computing devices. Communication connection(s) 826 may include a wired connection or a wireless connection. Communication connection(s) 826 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 812 may include input device(s) 824 such as keyboard, mouse, pen, voice input device, touch input device, infrared cameras, video input devices, and/or any other input device. Output device(s) 822 such as one or more displays, speakers, printers, and/or any other output device may also be included in device 812. Input device(s) 824 and output device(s) 822 may be connected to device 812 via a wired connection, wireless connection, or any combination thereof. In one embodiment, an input device or an output device from another computing device may be used as input device(s) 824 or output device(s) 822 for computing device 812.

Components of computing device 812 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 812 may be interconnected by a network. For example, memory 818 may be comprised of multiple physical memory units located in different physical locations interconnected by a network.

Those skilled in the art will realize that storage devices utilized to store computer readable instructions may be distributed across a network. For example, a computing device 830 accessible via network 828 may store computer readable instructions to implement one or more embodiments provided herein. Computing device 812 may access computing device 830 and download a part or all of the computer readable instructions for execution. Alternatively, computing device 812 may download pieces of the computer readable instructions, as needed, or some instructions may be executed at computing device 812 and some at computing device 830.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for interactive television, comprising:
identifying a desired contextual probability factor based on consumer contextual information;
activating contextual content to run concurrently with television programming, where the activated contextual content is selected based on a desired consumer interest probability factor; and
responding to a consumer interaction with the contextual content by providing corresponding response information to be sent to an associated consumer device.

2. The method of claim 1, comprising identifying consumer contextual information.

3. The method of claim 2, identifying consumer contextual information comprising indentifying consumer contextual information using one or more of:
a broadcasting control system that provides television programming for the consumer;
one or more sensors that detect contextual information; and
a set top box that receives the television programming and delivers the programming to a consumer's television.

4. The method of claim 2, identifying consumer contextual information comprising indentifying one or more of:
programming information;
time;
consumer identity; and
consumer location.

5. The method of claim 1, comprising identifying consumer preferences, comprising indentifying one or more of:
a contextual content type preference;
a contextual content display preference;
a consumer timing preference; and
a contextual content delivery preference.

6. The method of claim 5, identifying consumer preferences, comprising identifying consumer preferences based on historical consumer interaction with contextual content.

7. The method of claim 5, comprising identifying the desired contextual probability factor based on consumer contextual information and consumer preferences.

8. The method of claim 1, comprising identifying the desired contextual probability factor comprising identifying a probability for a contextual content based on current programming viewed by the consumer for a current location of the consumer.

9. The method of claim 1, comprising selecting the contextual content for activation comprising comparing the desired contextual probability factor against a database of contextual contents.

10. The method of claim 9, comprising selecting the contextual content for activation that comprises a closest match to the desired contextual probability factor.

11. The method of claim 1, activating the contextual content comprising using a set top box to run the contextual content so that the content can be viewed by the consumer at a same time as the television programming from a broadcasting control system.

12. The method of claim 1, responding to a consumer interaction with the contextual content comprising responding to a remote control interaction with the contextual content by the consumer.

13. The method of claim 1, sending corresponding response information to the associated consumer device comprising sending response information to one or more of:
an associated consumer selected mobile device;
a third-party device used to provide the third-party with consumer contact information; and
a consumer selected online service device used to link the consumer with information about the contextual content.

14. A system for interactive television, comprising:
a context identification component configured to identify contextual information for a consumer of the interactive television from at least one of:
a broadcast control service providing television content to the consumer, communicatively coupled with the context identification component; and
a set-top box operably coupled with a consumer television content display, and communicatively coupled with the context identification component;
an information content determination component operably coupled with the context identification component, and configured to identify information content to be concurrently run with the television content on the consumer's television content display; and
a consumer response component operably coupled with the set-top box, and configured to send response information to an associated consumer device in response to a consumer interaction with the information content.

15. The system of claim 14, comprising an information content database comprising a plurality of information content segments, and operably coupled with the information content determination component.

16. The system of claim 14, the identified information content configured to be displayed at a same time as the television content to the consumer.

17. The system of claim 14, the information content comprising one of:
an advertisement; and
consumer added value service.

18. The system of claim 14, the information content determination component comprising a probability determination component configured to:
combine the contextual information with an information content to determine a consumer interest probability; and
select the information content having a desired consumer interest probability.

19. The system of claim 14, the consumer response component configured to send one or more of:
additional information about a subject of the information content to an associated consumer device;
a sale related offer for a subject of the information content to an associated consumer device;
purchased content related to a subject of the information content to an associated consumer device;
consumer contact information to a third-party; and
consumer preference information to the information content determination component;

20. A method for interactive television, comprising:
identifying consumer contextual information using a broadcasting control system that provides content programming for the consumer and a set top box that receives the content programming and delivers the programming to a consumer's content display, the consumer contextual information comprising one or more of:
programming information;
time;
consumer identity; and
consumer location;
identifying consumer preference information comprising indentifying one or more of:
a consumer interest information type preference;
a consumer interest information display preference;
a consumer timing preference; and
a consumer interest information delivery preference;
identifying a desired consumer interest probability factor based on the consumer contextual information and consumer preference information, comprising identifying a probability for consumer interest information content based on current programming viewed by the consumer for a current location of the consumer combined with the consumer preference information;
selecting the consumer interest information content by comparing the consumer interest probability factor against a database of consumer interest information contents;
activating the selected consumer interest information content using a set top box to run the consumer interest information content so that the content can be viewed by the consumer at a same time as the television programming from a broadcasting control system; and
responding to a consumer interaction with the consumer interest information content by sending corresponding response information to an associated consumer device.
